(19) United States
(12) Patent Application Publication
(10) Pub. No.: US 2026/0162159 A1
(43) Pub. Date: Jun. 11, 2026

(54) REAL TIME PAYMENT SYSTEM ARCHITECTURE AND PAYMENT PROCESSING METHOD

(71) Applicants: Orli Carlos Machado, Aventura, FL (US); C&M SOFTWARE LLC, Miami, FL (US)

(72) Inventor: Orli Carlos MACHADO, Aventura, FL (US)

(21) Appl. No.: 18/972,666

(22) Filed: Dec. 6, 2024

(51) Int. Cl. G06Q 30/04; G06Q 20/38

(52) U.S. Cl. CPC G06Q 30/04; G06Q 20/3823; G06Q 20/3829; G06Q 20/385

(57) ABSTRACT

A real-time payment system architecture and payment processing method are disclosed, and which are designed to enhance functionality and user experience, improve efficiency, interoperability and scalability, ensure security and operational cost savings resulting from minimizing the need for extensive use of computer hardware and network resources. The real-time payment system architecture and payment processing method contains features including user identification and onboarding which simplifies the onboarding process, reducing friction and increasing user adoption; user authorization and consent facilitation which simplifies the payment/transfer authorization process between users; processing of one or more batch authorization requests which allows greater use flexibility and adaptability for diverse market intricacies and specificities; dynamic path selection in billing one or more processes which improves efficiency and reduces operational costs; billing and collection portability which enhances interoperability and user convenience; QR code-based billing and collection which reduces errors and improving efficiency, and visualization and management of billing charges which enhances transparency and enables better financial management.

### BACKGROUND OF INVENTION

### Field of the Invention

The present invention relates to digital payment processing systems and, more specifically, to real-time payment systems and methods. More specifically, it pertains to a novel and inventive real-time payment system architecture and payment processing method that integrates advanced technical features such as user identification via social media accounts or aliases and payment key registration, QR code-based billing and collection, comprehensive visualization and management of billing charges, dynamic path selection in billing processes, and billing and collection portability. The real-time payment system architecture and payment processing method are further enhanced with AI-enabled, quantum computing, and advanced cybersecurity capabilities and measures to ensure efficiency, security, and scalability.

### Description of Related Art

Traditional payment systems often suffer from various inefficiencies and limitations. These systems typically require users to undergo lengthy and cumbersome onboarding processes, which can deter potential users and slow down the adoption rate. Additionally, manual billing and collection processes are prone to errors and inefficiencies, leading to increased operational costs and reduced user satisfaction.

Existing systems also lack comprehensive tools for the real-time visualization, management, and monitoring of billing charges. This lack of transparency can result in poor financial management and decision-making. Furthermore, static billing processes are often inflexible and inefficient, failing to adapt to changing conditions and user needs.

Portability of billing and collection data across different platforms and systems is another significant challenge. Users often face difficulties in transferring their billing information, leading to inconvenience and potential data loss. Moreover, traditional payment systems are vulnerable to cyber threats, posing significant risks to user data and transaction security.

There is, thus, a need for a holistic, real-time payment system architecture and method that integrates several novel and inventive technical features that address many of these technical, operational and practical financial technology challenges and that offers technical, operational and strategic advantages. Moreover, recent advancements in technology, including AI, quantum computing, and cybersecurity, present opportunities to address these challenges. By leveraging these technologies, it is possible to develop a real-time payment system architecture and system that not only enhances user experience but also improves operational efficiency and security for financial institutions.

### SUMMARY OF THE INVENTION

An object of the present invention is to provide a comprehensive real-time payment system and payment processing method designed to enhance functionality and user experience, improve efficiency, interoperability and scalability, ensure security and operational cost savings, and minimizing the need for extensive use of computer hardware and network resources through the following features:
1. User Identification and Onboarding: The system allows users to sign up and onboard using their social media accounts or aliases, thereby simplifying the onboarding process, reducing friction and increasing user adoption.
2. User Authorization and Consent Facilitation: The system facilitates user authorization and consent, thereby simplifying the payment/transfer authorization process between users by providing the technology for the process to be safe, simple, and transparent for users on both sides of a payment/transfer transaction.
3. Processing of Batch Authorization Requests: The system process batch authorization requests. This feature uses a standardized file which meets all economic sectors of the financial industry and allows greater flexibility in its use, on top of being very adaptable to the diverse market intricacies and specificities.
4. Dynamic Path Selection in Billing Processes: The system includes a dynamic path selection module that optimizes billing routes based on real-time data, thereby enhancing efficiency, reduces operational costs, and minimizing the need for extensive use of computer hardware and network resources. Distinct from existing systems, the dynamic path selection module leverages real-time data to ensure the most efficient and reliable routing, thus improving overall performance and reducing costs.
5. Billing and Collection Portability: The system ensures the seamless portability of billing and collection data across different platforms, thereby enhancing interoperability and user convenience.
6. QR Code-Based Billing and Collection: The system utilizes QR codes for billing and collection purposes, thereby automating data entry and payment processes, reducing errors and improving efficiency.
7. Visualization and Management of Billing Charges: The system provides advanced tools for the real-time visualization, management, and monitoring of billing charges, thereby enhancing transparency and enabling better financial management.

Another object of the present invention is to provide a real-time payment system and payment processing method further enhanced with AI-enabled, quantum computing, and cybersecurity capabilities and measures including:
AI Module: The AI engine enhances user experience, optimizes billing processes, and detects fraudulent activities. It leverages machine learning algorithms to verify the authenticity of social media accounts or aliases and provides personalized financial insights to users.
Quantum Computing Module: The quantum computing engine solves complex optimization problems in real-time, further enhancing efficiency and decision-making.
Cybersecurity Module: The cybersecurity module protects the system against cyber threats, ensuring secure transactions and safeguarding user data.

Yet another object of the present invention is to provide a real-time payment system and payment processing method offering specific numerous technical benefits and advantages for users and financial institutions:
1. Enhanced User Experience: Simplified onboarding and seamless payment processes improve user satisfaction and retention.
2. Increased Efficiency: Automation of billing and collection reduces manual effort, minimizes errors, and speeds up transactions.
3. Real-time Insights: Visualization tools provide real-time data, enabling better decision-making and financial management.
4. Cost Savings: Optimized billing routes and automated processes reduce operational costs and minimize the need for extensive use of computer hardware and network resources.
5. Improved Security: AI and quantum computing enhance security measures, protecting against fraud and cyber threats plus real-time monitoring and dynamic path selection not only enhances the security of transactions but also ensures compliance with regulatory requirements.
6. Scalability: The system can easily scale to accommodate growing user bases and transaction volumes.
7. Interoperability: Portability features ensure compatibility with various platforms and systems, enhancing flexibility, adaptability and user convenience.

Yet another object of the present invention is to provide a real-time payment system and payment processing method offering additional specific technical benefits and advantages for users and financial institutions by virtue of the combined benefits of their features creating a robust, user-centric architecture that is efficient, transparent and highly adaptable to various user needs and preferences and which include:
1. Increased Adoption and Engagement: The ease of onboarding and user-friendly features can attract a larger user base and keep them engaged.
2. Operational Efficiency: QR codes and dynamic path selection can streamline operations, reduce costs, and improve transaction speed.
3. User Empowerment: Enhanced visualization and management tools empower users to take control of their finances, leading to better financial health.
4. Flexibility and Convenience: Portability features ensure that users have a seamless experience across different platforms, enhancing overall satisfaction.
5. Competitive Advantage: Offering such advanced and combined features can provide a competitive edge, attracting more customers and retaining existing ones.

Yet another object of the present invention is to provide a real-time payment system and payment processing method offering additional technical benefits and advantages further enhancing their value including:
1. AI-Driven Personalization: AI can analyze user behavior to offer personalized financial services and recommendations.
2. Quantum Computing for Optimization: Quantum computing can solve complex optimization problems in real-time, further enhancing efficiency and decision-making.
3. Advanced Fraud Detection: AI and quantum computing can detect and prevent fraudulent activities with greater accuracy and speed.
4. Seamless Integration with IoT: The system can integrate with IoT devices for automated payments and enhanced user experiences.
5. Global Reach: Enhanced portability and interoperability features can facilitate cross-border transactions, expanding the system's global reach.

### BRIEF DESCRIPTION OF THE DRAWINGS

The above-mentioned and other features of the invention disclosed herein are described below with reference to the drawings of the preferred embodiments. The illustrated embodiments are intended to illustrate, but not limit, the invention. The drawings contain the accompanying figures:

FIG. 1 illustrates a diagrammatic view of a preferred embodiment of the real-time payment system architecture of present invention.

FIG. 2 illustrates a diagrammatic view of another preferred embodiment of the real-time payment system architecture of the present invention.

FIG. 3 illustrates a diagrammatic view of a preferred embodiment of the user identification and key registration module of the real-time payment system architecture of the present invention.

FIG. 4 illustrates a diagrammatic view of a preferred embodiment of the user authorization and consent facilitation module of the real-time payment system architecture of the present invention.

FIG. 5 illustrates a diagrammatic view of a preferred embodiment of the processing module of the real-time payment system architecture of the present invention.

FIG. 6 illustrates a diagrammatic view of a preferred embodiment of the dynamic path selection module of the real-time payment system architecture of the present invention.

FIG. 7 illustrates a diagrammatic view of a preferred embodiment of the portability management module of the real-time payment system architecture of the present invention.

FIG. 8 illustrates a diagrammatic view of a preferred embodiment of the QR Code generation and storage module of the real-time payment system architecture of the present invention.

FIG. 9 illustrates a diagrammatic view of a preferred embodiment of the visualization and management module of the real-time payment system architecture of the present invention

FIG. 10 illustrates a diagrammatic view of a preferred embodiment of the AI module of the real-time payment system architecture of the present invention.

FIG. 11 illustrates a diagrammatic view of a preferred embodiment of the quantum computing module of the real-time payment system architecture of the present invention.

FIG. 12 illustrates a diagrammatic view of a preferred embodiment of the cybersecurity module of the real-time payment system architecture of the present invention.

FIG. 13 shows a flowchart of a method for user identification and key registration and associated user identification and key registration module of a preferred embodiment of the real-time payment system architecture of the present invention.

FIG. 14 shows a flowchart of a method for user identification and key registration and associated user identification and key registration module of a preferred embodiment of the real-time payment system architecture of the present invention.

FIG. 15 shows a flowchart of a method for user identification and key registration and associated user identification and key registration module of a preferred embodiment of the real-time payment system architecture of the present invention.

FIG. 16 shows a flowchart of a method for facilitating user authorization and consent and associated user authorization and consent facilitation module of a preferred embodiment of the real-time payment system architecture of the present invention

FIG. 17 shows a flowchart of a method for facilitating user authorization and consent and associated user authorization and consent facilitation module of a preferred embodiment of the real-time payment system architecture of the present invention.

FIG. 18 shows a flowchart of a method for dynamically selecting optimal paths for one or more billing processes based on real-time data and associated dynamic path selection module of a preferred embodiment of the real-time payment system architecture of the present invention.

FIG. 19 shows a flowchart of a method for managing the portability of billing and collection data across different platforms and associated portability management module of a preferred embodiment of the real-time payment system architecture of the present invention.

FIG. 20 shows a flowchart of a method for generating and processing QR codes for billing and collection purposes and associated QR code generation and storage module of a preferred embodiment of the real-time payment system architecture of the present invention.

FIG. 21 shows a flowchart of a method for generating and processing QR codes for billing and collection purposes and associated QR code generation and storage module of a preferred embodiment of the real-time payment system architecture of the present invention.

### DETAILED DESCRIPTION OF THE INVENTION

The following disclosure is presented to provide an illustration of the general principles of the present invention and is not meant to limit, in any way, the inventive concepts contained herein. Moreover, the described in this section can be used in combination with the other described features in each of the multitude of possible permutations and combinations contained herein.

All terms defined herein should be afforded broadest possible interpretation, including any meanings as dictated by a reading of the specification as well as any words that a person having skill in the art and/or a dictionary, treatise, or similar authority would assign thereto.

Further, it should be noted that, as recited herein, the singular forms ‘a,’ “an,” and “the” include the plural referents unless otherwise stated. Additionally, the terms “comprise” and “comprising” when used herein specify that certain features are present in that embodiment, however, this phrase should not be interpreted to preclude the presence or additional operations, features, components, and/or groups thereof.

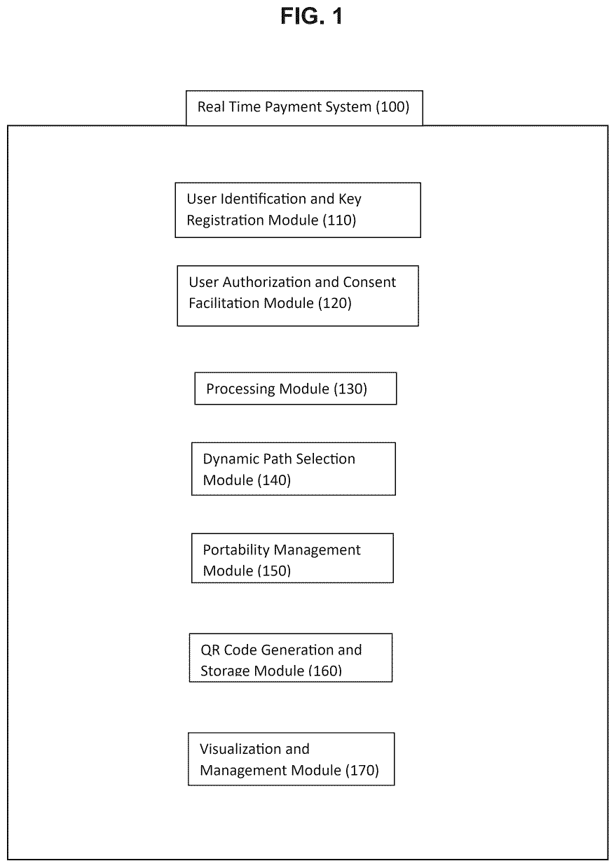

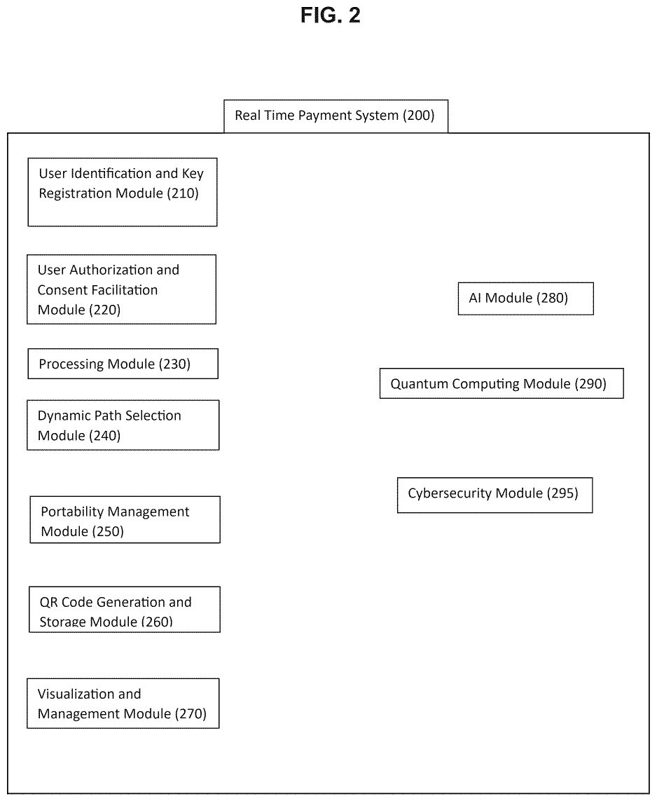

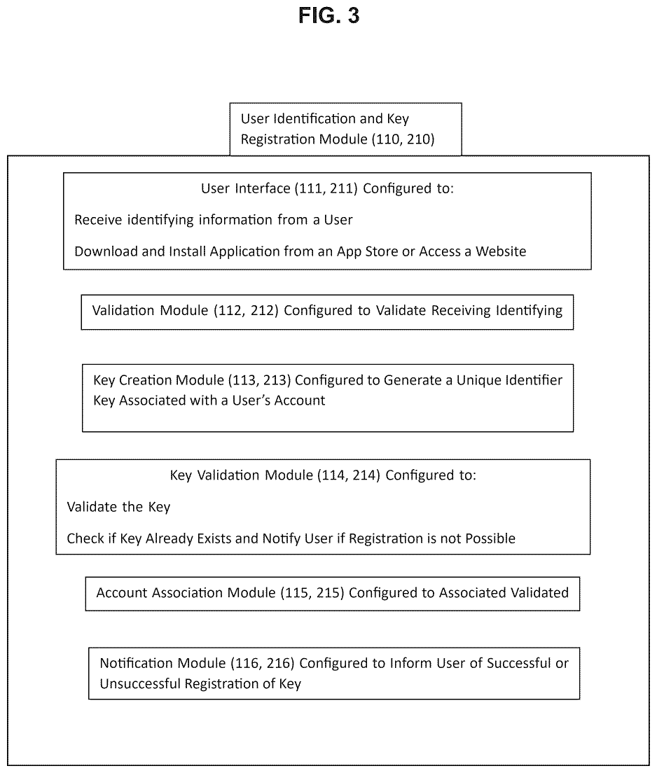

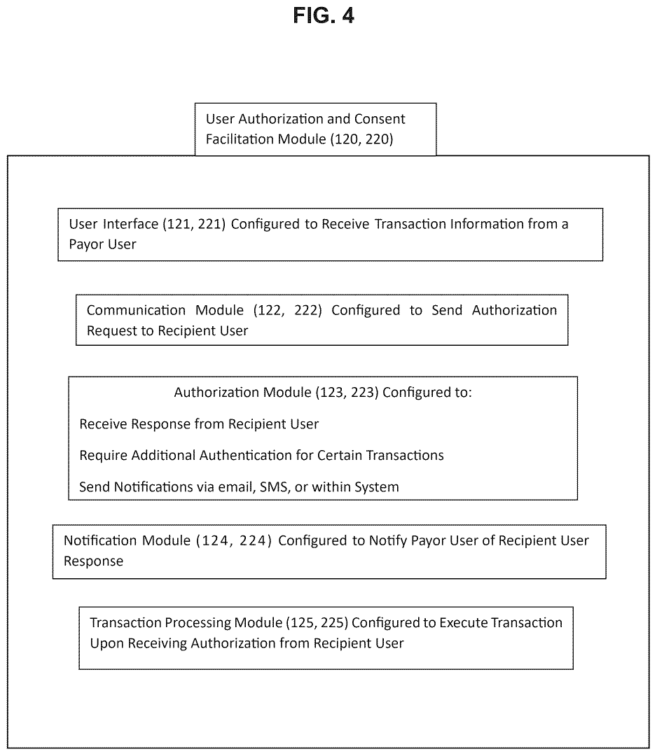

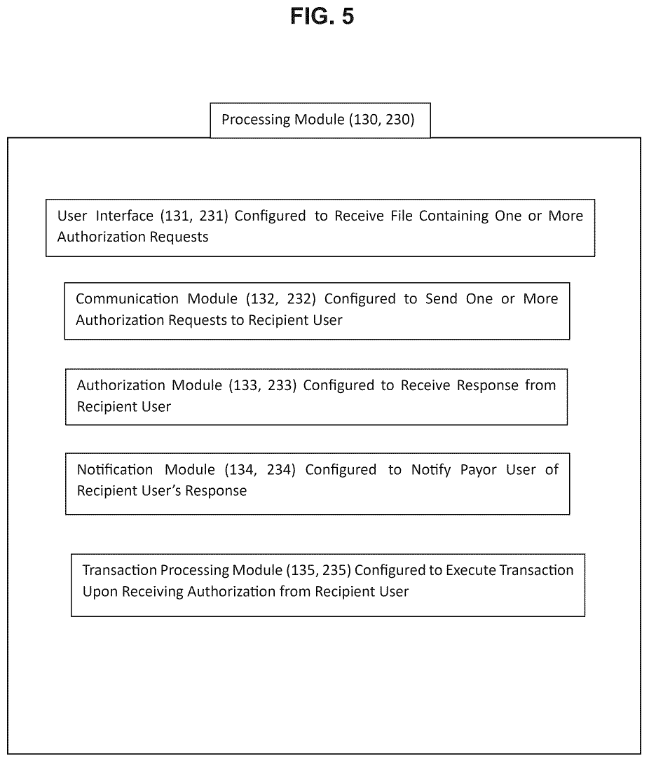

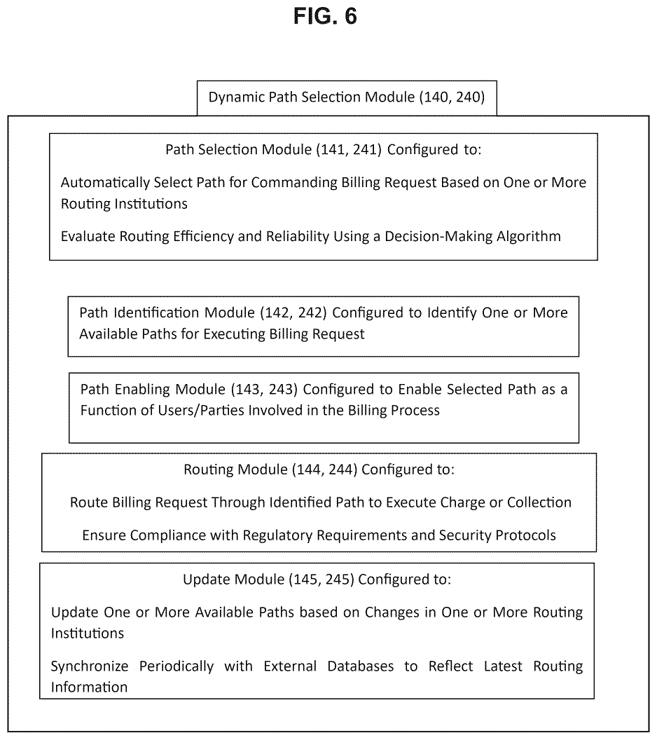

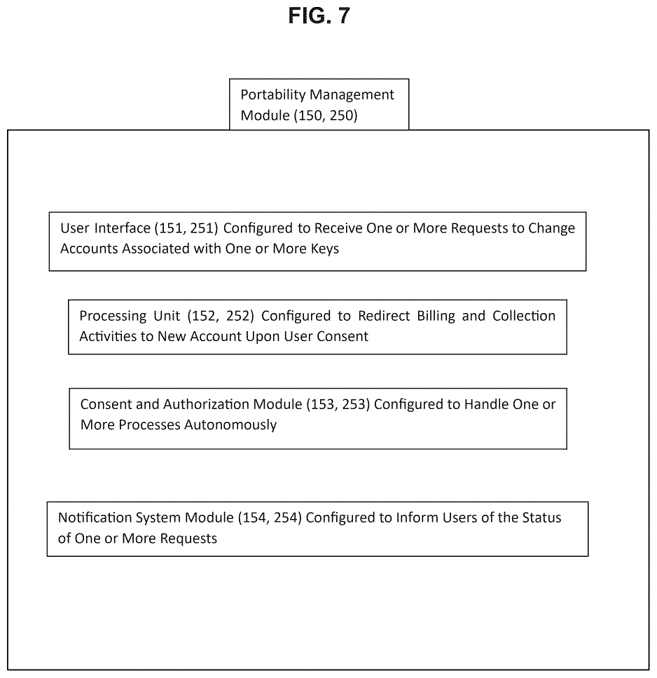

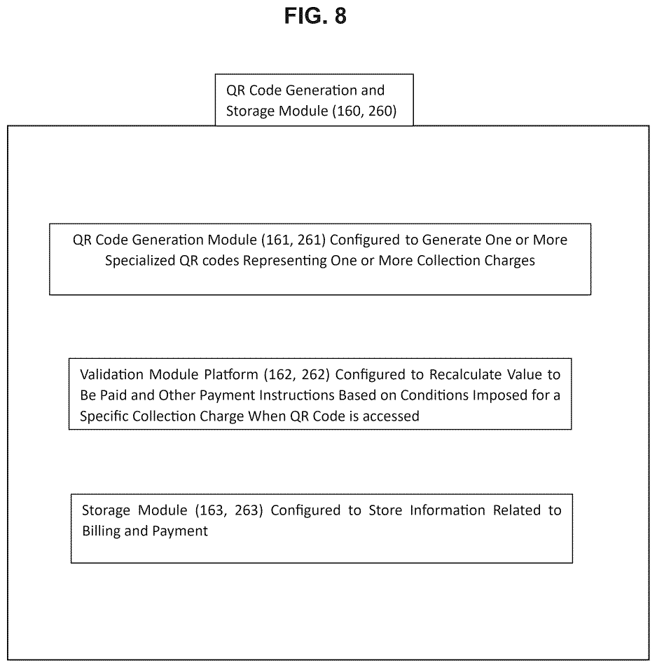

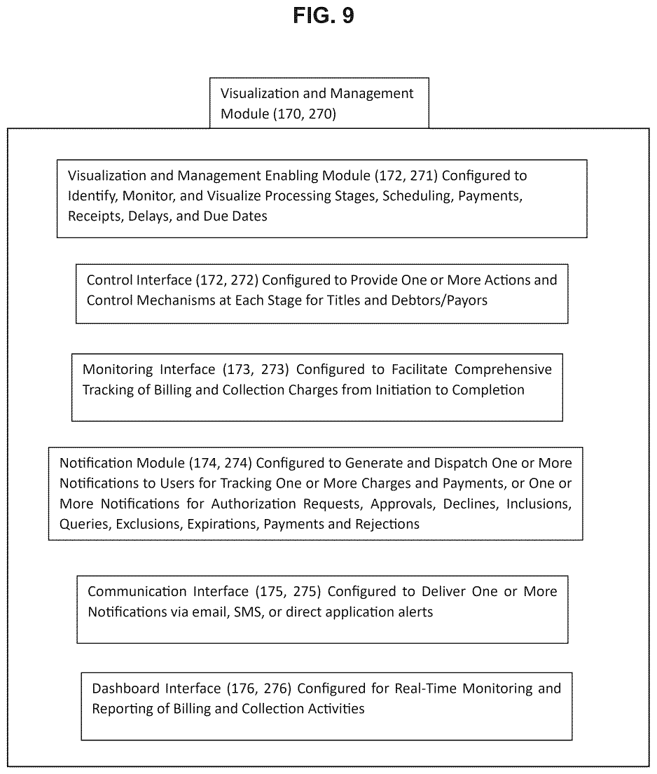

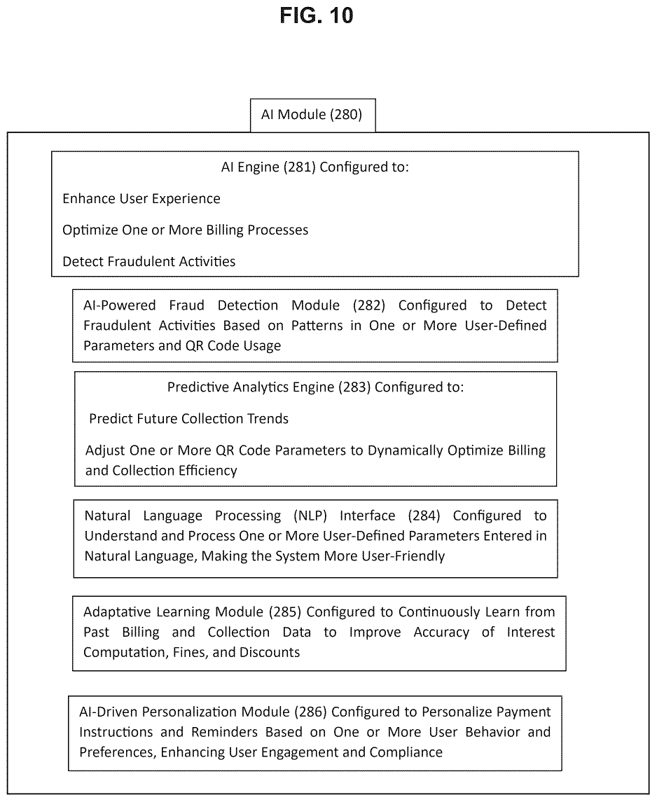

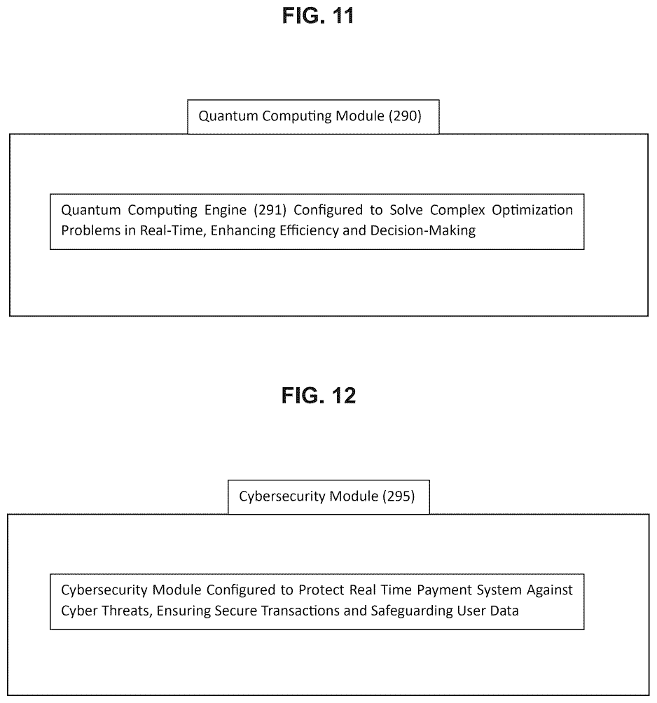

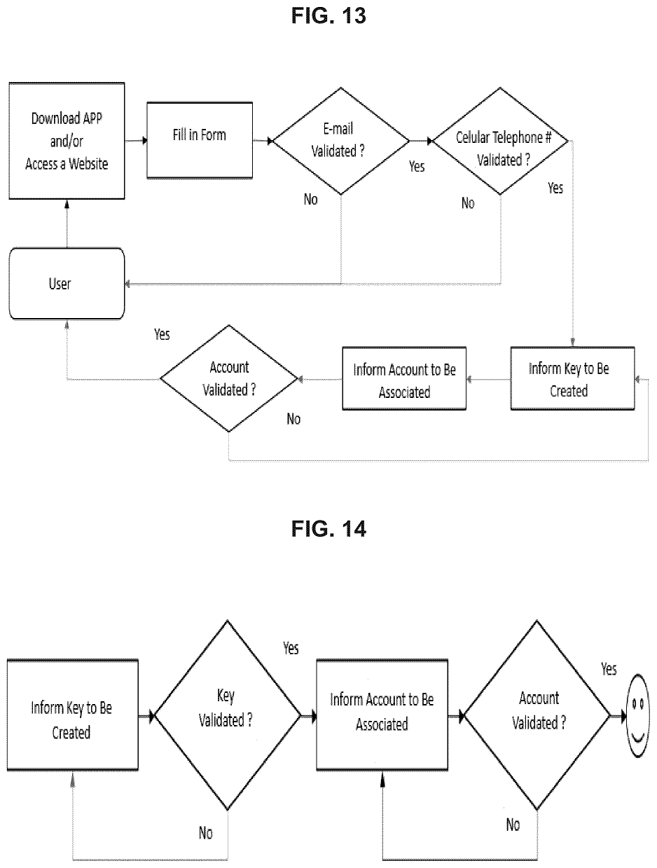

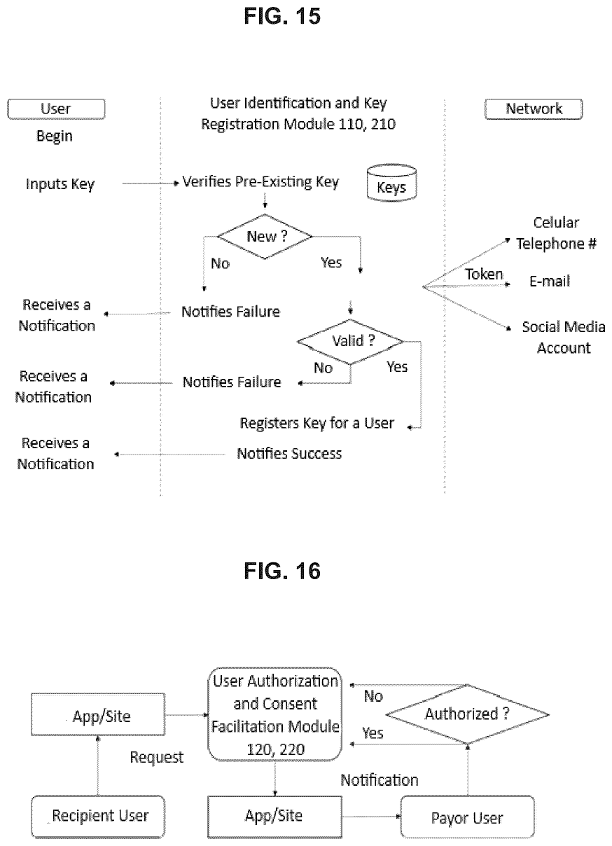

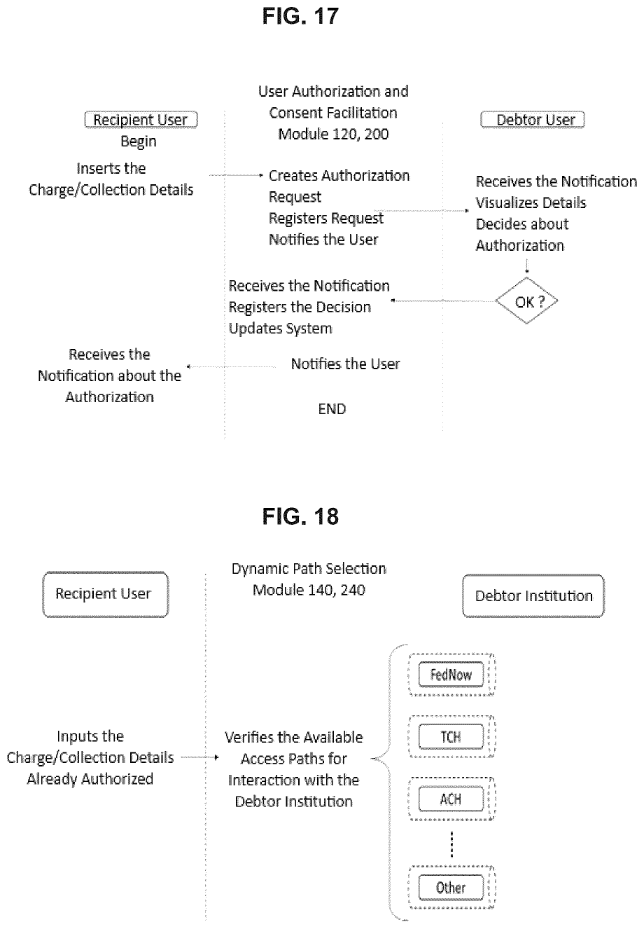

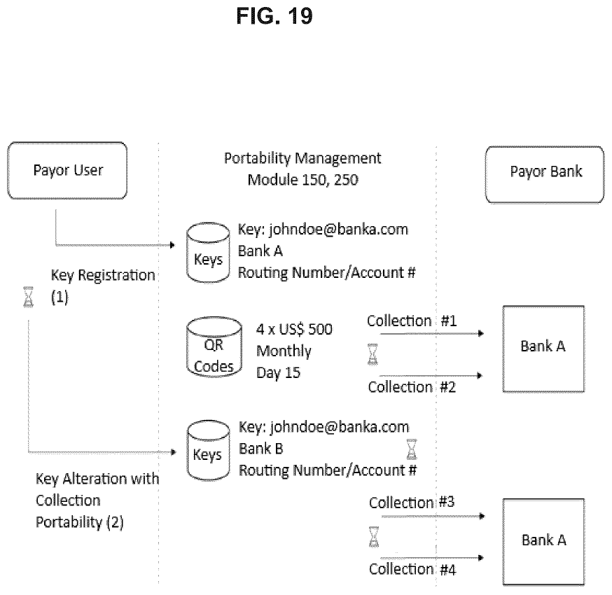

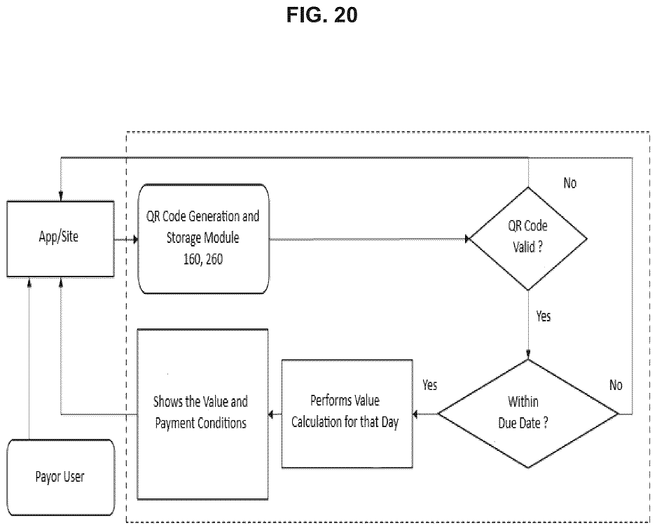

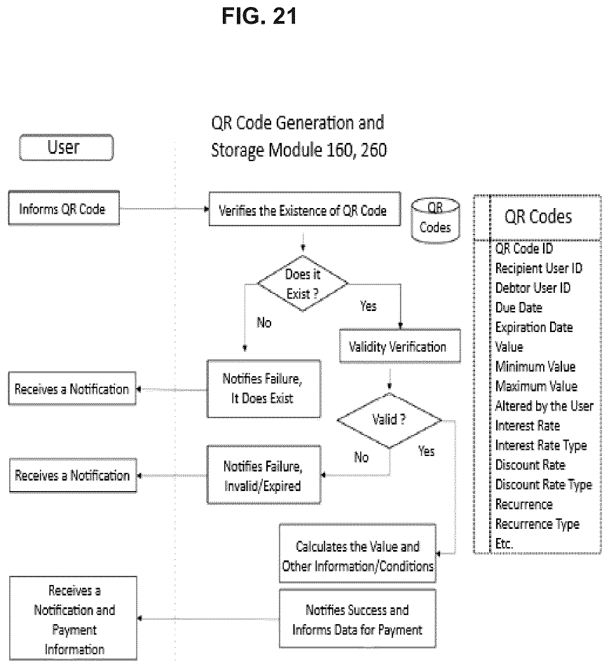

As shown in FIGS. 1 through 21, a real-time payment system architecture 100, 200 and payment processing method designed to enhance functionality and user experience, improve efficiency, interoperability and scalability, ensure security and operational cost savings resulting from the minimization of the need of extensive use of computer hardware and network resources are disclosed.

More specifically, the real-time payment system architecture 100, 200 of the present invention, as illustrated, explained and implemented in FIGS. 1 through 21, comprises a user identification and key registration module 110, 210; a user authorization and consent facilitation module 120, 220; a processing module 130, 230; a dynamic path selection module 140, 240; a portability management module 150, 250; a QR code generation and storage module 160, 260; and a visualization and management module 170, 270.

In a specific and alternative embodiment of the real-time payment system architecture 100, 200 of the present invention, the real-time payment system architecture 100, 200 includes a user identification and key registration module 110, 210 configured to: (1) receive identifying information from a user via a user interface, including but not limited to name, physical address, email address, and cellular telephone number; (2) validate the received identifying information via a validation module; (3) generate a unique identifier key associated with a user's account via a key creation module, wherein the key is selected from a group consisting of email address, cellular phone number, social network account login/username, and generic identifier; (4) validate the key, except for the generic identifier, via a key validation module; (5) associate the validated key with a current, updated, and live account of the user via an account association module; and (6) inform the user of the successful or unsuccessful registration of the key via a notification module; a user authorization and consent facilitation module 120, 220 configured to: (1) receive transaction information from a payor user via a user interface, including the payor's key, transaction amount, and due date; (2) send an authorization request to a recipient user via a communication module; (3) receive a response from the recipient user via an authorization module, the response indicating authorization or denial of the transaction; (4) notify the payor user of the recipient user's response via a notification module; and (5) execute a transaction upon receiving authorization from the recipient user via a transaction processing module; a processing module 130, 230 configured to: (1) receive a file containing one or more authorization requests via a user interface, each request including transaction details such as value, description, and due date; (2) send one or more authorization requests to a respective recipient user via a communication module; (3) receive a response from the recipient user via an authorization module, each response indicating authorization or denial of the respective transaction; (4) notify the payor user of the recipient users' response via a notification module; and (5) execute the transaction upon receiving authorization from the recipient user via a transaction processing module; a dynamic path selection 140, 240 module configured to: (1) automatically select a path for commanding a billing request based on one or more routing institutions associated with one or more keys involved in a billing process via a path selection module; (2) identify, using a routing number, one or more available paths for executing the billing request from a group of options including FedNow, TCH, and ACH via a path identification module; (3) enable the selected path as a function of the users/parties involved in the billing process via a path enabling module; and (4) route the billing request through the identified path to execute the charge or collection via a routing module; a portability management module 150, 250 configured to: (1) receive one or more requests to change accounts associated with one or more keys via a user interface; (2) redirect billing and collection activities to a new account upon user consent via a processing unit; (3) handle consent and authorization processes autonomously via a consent and authorization module; and (4) inform users of the status of the one or more requests via a notification system module; a QR code generation and storage module 160, 260 configured to: (1) generate specialized QR codes representing collection charges via a QR code generation module; (2) recalculate the value to be paid, and other payment instructions based on the conditions imposed for a specific collection charge when the QR Code is accessed via a validation module platform; and (3) store information related to billing and payment via a storage module; and a visualization and management module 170, 270 configured to: (1) identify, monitor, and visualize processing stages, scheduling, payments, receipts, delays, and due dates via a visualization and management enabling module; (2) provide actions and control mechanisms at each stage for titles and debtors/payors via a control interface; (3) facilitate comprehensive tracking of billing and collection charges from initiation to completion via a monitoring interface; and (4) provide real-time monitoring and reporting of billing and collection activities via a dashboard interface.

In a more specific and alternative embodiment of the real-time payment system architecture 100, 200 of the present invention, the real-time payment system architecture includes a processor and a memory storing instructions that, when executed by the processor, cause the processor to perform the operations carried out by each one of the user identification and key registration module 110, 210, the user authorization and consent facilitation module 120, 220, the processing module 130, 230, the dynamic path selection module 140, 240, the portability management module 150, 250, the QR code generation and storage module 160, 260, and the visualization and management module 170, 270 and derivative modules, user interfaces and processing unit that are part of thereof.

The payment processing method implemented into the real-time payment system architecture 100, 200 of the present invention includes the steps of user identification and key registration via a user identification and key registration module 110, 210; user authorization and consent facilitation through a user authorization and consent facilitation module 120, 220; processing of one or more batch authorization requests using a processing module 130, 230; dynamic path selection through a dynamic path selection module 140, 240; portability management across different platforms via a portability management module 150, 250; generating and processing QR codes for billing and collection purposes using a QR code generation and storage module 160, 260; and providing visualization, management, and monitoring of collection and billing charges through a visualization and management module 170, 270.

In a specific and alternative embodiment of the payment processing method implemented into the real-time payment system architecture 100, 200 of the present invention, the payment processing method includes the steps of user identification and key registration via user identification and registration module 110, 210 by: (1) receiving identifying information from a user via a user interface, including but not limited to name, physical address, email address, and cellular telephone number; (2) validating the received identifying information via a validation module; (3) generating a unique identifier key associated with a user's account via a key creation module, wherein the key is selected from a group consisting of email address, cellular phone number, social network account login/username, and generic identifier; (4) validating the key, except for the generic identifier, via a key validation module; (5) associating the validated key with a current, updated, and live account of the user via an account association module; and (6) informing the user of the successful or unsuccessful registration of the key via a notification module; user authorization and consent facilitation through a user authorization and consent facilitation module 120, 220 by: (1) receiving transaction information from a payor user via a user interface, including the payor's key, transaction amount, and due date; (2) sending an authorization request to a recipient user via a communication module; (3) receiving a response from the recipient user via an authorization module, the response indicating authorization or denial of the transaction; (4) notifying the payor user of the recipient user's response via a notification module; and (5) executing a transaction upon receiving authorization from the recipient user via a transaction processing module; processing of one or more batch authorization requests using a processing module 130, 230 by: (1) receiving a file containing one or more authorization requests via a user interface, each request including transaction details such as value, description, and due date; (2) sending one or more authorization requests to a respective recipient user via a communication module; (3) receiving a response from the recipient user via an authorization module, each response indicating authorization or denial of the respective transaction; (4) notifying the payor user of the recipient users' response via a notification module; and (5) executing the transaction upon receiving authorization from the recipient user via a transaction processing module; dynamic path selection through a dynamic path selection module 140, 240 by: (1) automatically selecting a path for commanding a billing request based on one or more routing institutions associated with one or more keys involved in a billing process via a path selection module; (2) identifying, using a routing number, one or more available paths for executing the billing request from a group of options including FedNow, TCH, and ACH via a path identification module; (3) enabling the selected path as a function of the users/parties involved in the billing process via a path enabling module; and (4) routing the billing request through the identified path to execute the charge or collection via a routing module; portability management across different platforms via a portability management module 150, 250 by: (1) receiving one or more requests to change accounts associated with one or more keys via a user interface; (2) redirecting billing and collection activities to a new account upon user consent via a processing unit; (3) handling consent and authorization processes autonomously via a consent and authorization module; and (4) informing users of the status of the one or more requests via a notification system module; generating and processing QR codes for billing and collection purposes using a QR code generation and storage module 160, 260 by: (1) generate specialized QR codes representing collection charges via a QR code generation module; (2) recalculating the value to be paid, and other payment instructions based on the conditions imposed for a specific collection charge when the QR Code is accessed via a validation module platform; and (3) storing information related to billing and payment via a storage module; and providing visualization, management, and monitoring of collection and billing charges through a visualization and management module 170, 270 by: (1) identifying, monitoring, and visualizing processing stages, scheduling, payments, receipts, delays, and due dates via a visualization and management enabling module; (2) providing actions and control mechanisms at each stage for titles and debtors/payors via a control interface; (3) facilitating comprehensive tracking of billing and collection charges from initiation to completion via a monitoring interface; and (4) providing real-time monitoring and reporting of billing and collection activities via a dashboard interface.

In a more specific and alternative embodiment of the payment processing method implemented into the real-time payment system architecture 100, 200 of the present invention, the payment processing method includes the steps of providing a processor and a memory, wherein the memory stores instructions that, when executed by the processor, cause the processor to perform operations carried out by each one of the user identification and key Registration module 110, 210, the user authorization and consent facilitation module 120, 220, the processing module 130, 230, the dynamic path selection module 140, 240, the portability management module 150, 250, the QR code generation and storage module 160, 260, and the visualization and management module 170, 270 and derivative modules, user interfaces and processing unit that are part of thereof.

Additional details of the implementation of real-time payment system architecture 100, 200 and payment processing method of the present invention are discussed below.

The real-time payment system architecture 100, 200 and payment processing method may be incorporated, integrated, embedded or added and implemented across different scenarios and terminals including e-commerce, P2P, ATM, POS terminals, social networking commerce and m-commerce. The real-time payment system architecture 100, 200 and payment processing method may include or be implemented using one or more processors, one or more communication interfaces, one or more displays, and miscellaneous hardware. Each one of the one or more processors may be a single-core processor or a multi-core processor. The communication interface(s) facilitate communication with components inside or outside of the real-time payment system architecture 100, 200 and payment processing method and provide networking capabilities for the real-time system architecture and payment processing method. For example, the real-time payment system architecture 100, 200 and payment processing method, by way of the communications interface, may exchange data with other electronic devices (e.g. laptops, computers, other servers, etc. . . . ) via one or more networks, such as the Internet or a local network. Communications between the real-time payment system architecture 100, 200 and payment processing method may utilize any sort of communication protocol known in the art for sending and receiving data and/or voice communications. The one or more displays may be a typical smart phone display but may also be an external display used with a smart phone or other type of electronic device. The miscellaneous hardware may include hardware components and associated software and/or firmware used to carry out device operations and include one or more user interface hardware components that support user interaction with the real-time payment system architecture 100, 200 and payment processing method such as the typical smart phone or other type of electronic device. The real-time payment system architecture 100, 200 and payment processing method may include or be implemented using a smart phone that also includes a memory that stores data, executable instructions, modules, components, data structures, etc. and using computer readable media. An operating system may be stored in the memory of the smart phone or other type of electronic device included or being implemented in the real-time payment system architecture 100, 200 and payment processing method that controls functionality of the one or more processors, the one or more communication interfaces, the one or more displays, and the miscellaneous hardware, and may include components that enable the smart phone or other type of electronic device to receive and transmit data via various inputs (e.g. user controls, network interfaces, and/or memory devices) as well as process data using the one or more processors to generate output. The operating system may include components that controls the presentation of output (e.g. display the data on an electronic display, store the data in memory, transmit the data to another electronic device) and other components that perform various additional functions generally associated with a typical operating system. The memory may also store miscellaneous software applications, or programs, that provide or support functionality for the typical smart phone or other electronic devices, or provide a general or specialized device user function that may or may not be related to the typical smart phone or other electronic devices, and the software applications may include system software applications and executable applications that carry out non-real-time payment system architecture and payment processing method functions.

The real-time payment system architecture 100, 200 and payment processing method may be incorporated, integrated, embedded or added and implemented using computer readable media. Computer-readable media includes at least two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. Computer storage media may also be referred to as “non-transitory” media. Although, in theory, all storage media are transitory, the term “non-transitory” is used to contrast storage media from communication media and refers to a component that can store computer-executable programs, applications, and instructions, for more than a few seconds. In contrast, communication media may embody computer readable instructions, data structures, program modules, or other data in a modulated data signal, such as a carrier wave, or other transmission mechanism. Communication media may also be referred to as “transitory” media, in which electronic data may only be stored for a brief amount of time, typically under one second.

The real-time payment system 100, 200 of the present invention calls and associates a “key” for one or more aliases associated with one or more accounts with routing number and account number and, through the key, the accounts are be identified, provided and shared among parties involved in payment transactions and resource transfers.

The keys are elements already widely available, well known and used in large scales, such as email address, cellular phone number, social network account login/usernames, by parties with the most varied purposes. The real-time payment system 100, 200 allows users to register their accounts and assigns them aliases to themselves, thus greatly simplifying their use.

For example, consider the difference that there exists between two hypothetical situations where a party requests another party to make a transfer or payment:
“Please make a bank transfer in the amount of US$10.00 to an account with Routing Number 217129121 and Account Number 38923223923232”.

Or, more simply:
“Please make a bank transfer in the amount of US$10.00 to a key @johndoe”.

Using the key instead of account data for both payor and payee, there is greater ease and less error proneness in the payment transfer or transaction.

In addition to registering their accounts, the user can change or eliminate the account data at any time from the real-time payment system.

Both the registered keys or aliases as well as the account data themselves being assigned to the registered keys or aliases are validated and their respective possession/ownership are conferred in the registration/signing up process.

In addition to simplifying account identification, the real-time payment system architecture 100, 200 of the present invention simplifies the authorization process of transfers/payments between users providing a technology edge and advantage for the authorization process that is safe, simple and transparent for both payee/recipient and payor.

One or more users and one or more recipients of the real-time payment system 100, 200 interact with the real-time payment system by requesting transfers and authorizing payments between them. When a user requests a transfer, the user provides the real-time payment system with some information characterizing the charge/collection such as, for exemplary purposes, a payer's key, a payment/transfer value, a due date, an expiration date, discounts, fines/surcharges, interests, inter alia, and requests authorization of the payor. This authorization request is then forwarded to the recipient that may or may not authorize.

If authorized, a QRCode that uniquely identifies the charge is generated, stored and is consulted subsequently about its validity/authenticity, in addition to its other characteristics, updated value and other instructions for its corresponding payment.

### User Onboarding

The user onboarding and key registration process in the real-time payment system 100, 200 is initiated with activation followed by key creation and account association.

### Activation

To activate a user's registration in the real-time payment system 100, 200, the user carries out the following steps including downloading the app or accessing a website from any corresponding application store; installing the app and filling in identifying information including complete name, physical address, email address, or cellular telephone number. Once the inputted user data above is validated, the user proceeds to the next step.

### Key Creation

The user creates a first key which associates an existing account with a unique identifier serving as a user-friendly alternative for billing, collection and payment processes within the real-time payment system 100, 200. The types of keys may include email address, cellular telephone number (in international standard format), social network account (e.g., LinkedIn, Facebook, Instagram, inter alia) and/or generic identifier such as a single-word identifier in the real-time payment system 100, 200. All key types, except for generic, undergo validation before association with an account.

### Account Association

After validation, the key is associated with a current, updated or live account. The current, updated or live account is also validated to ensure the user's actual access to it.

Thus, the key may be associated with an account in a given institution as shown below in Table 1, for example:

| Key | Routing Number | Account Number |
|---|---|---|
| @johndoe | 217129121 | 38923223923232 |

### Key Registration

### Request Inclusion

A user initiates the inclusion process by typing the desired key (e.g., email address, cellular telephone number, or alias).

### Key Validation

The real-time payment system 100, 200 checks if the key already exists. If the key exists, then the user is informed that key registration is not possible.

If the key doesn't exist, then the real-time payment system 100, 200 validates the key and confirms user ownership. If the key is validated, the key is registered for the user and then the user notifies the user of successful registration. Whereas if the key is not validated, the user is notified of the validation failure and does not register the key.

With the process above, the key simplifies account identification and streamlines the payment process by using familiar identifiers.

In short, a method for user identification and key registration to be implemented in the real-time payment system 100,200 is disclosed comprising in an embodiment of the present invention the steps of receiving identifying information from a user, including name, physical address, email address or cellular telephone number; validating the received identifying information; generating a unique identifier key associated with a user's account, wherein the key is selected from a group consisting of email, cell number, social network account, and generic identifier; validating the key, except for the generic identifier; associating the validated key with a current, updated, and live account of the user; notifying the user of the successful or unsuccessful registration of the key. In an alternative embodiment of the present invention, the method for user identification and key registration comprises additionally allowing the user to download and install an application from an app store or access a website and checking if the key already exists and notifying the user if registration is not possible.

From the method of user identification and key registration, a real-time payment system module for user identification and key registration 110, 210 derives therefrom and that is configured and allows for a user to register and onboard the real-time payment system 100, 200 using a social network account or alias. The user identification and key registration module 110, 210 of the real-time payment system 100, 200 is configured and allows for a user to sign up and onboard the real-time payment system 100, 200 using a social media or alias comprises a user interface 111, 211 configured to receive identifying information from a user, including but not limited to name, physical address, email address, and cellular telephone number; a validation module 112, 212 configured to validate the received identifying information; a key creation module 113, 213 configured to generate a unique identifier key associated with a user's account, wherein the key is selected from a group consisting of email address, cellular number phone, social network account login/username, and generic identifier; a key validation module 114, 214 configured to validate the key, except for the generic identifier; an account association module 115, 215 configured to associate the validated key with a current, updated, and live account of the user; and a notification module 116, 216 configured to inform the user of the successful or unsuccessful registration of the key.

In an alternate embodiment of the user identification and key registration module 110, 210 of the real-time payment system 100, 200 of the present invention, the user interface 111, 211 is further configured to allow the user to download and install an application from an app store or access a website. In yet another embodiment of the user identification and key registration module 110, 210 of the real-time payment system 100, 200 of the present invention, the key validation module 114, 214 is further configured to check if the key already exists and notify the user if registration is not possible.

### Authorization and Consent

The real-time payment system architecture 100, 200 of the present invention simplifies the payment/transfer authorization process between users by providing the technology for the process to be safe, simple, and transparent for users on both sides of a payment/transfer transaction.

### User Interaction

Users interact with the real-time payment system 100, 200 requesting transfers and authorizing payments between them. When user wishes to request a transfer, the user provides the real-time payment system 100, 200 with information characterizing transaction such as payor's key, due date, expiration date, discounts, fines, interests, inter alia, and requests recipient/payee user authorization. This authorization request is then forwarded to the recipient which may or may not authorize the transaction.

### Charge Authorization Request

### Authorization Request

The process begins when the recipient user initiates an authorization request. In the authorization request, the recipient user enter charge/collection details such as transaction value, description, due date, other conditions, inter alia.

### Authorization Request Sending

The real-time payment system 100, 200 creates then the authorization request and a notification are sent to the payor user via email, SMS or within the real-time payment system alerting on the charge/collection authorization request.

### Request Review

The payor/debtor user receives the notification and visualizes thereafter the charge/collection details via a link or through the real-time payment system.

### Authorization Decision

The payor/debtor user has the option of authorizing or declining the charge. In certain situations, additional authentication may be required on the part of the payor/debtor user to confirm the decision.

### Response Processing

In the case of a positive response, the charge is then authorized, the real-time payment system 100, 200 notifies the user that the charge/collection has been authorized and then processes the charge.

In the case of a negative response, the charge is declined/denied and the real-time payment system 100, 200 notifies the user that the charge/collection has been declined/denied.

### Process End

The real-time payment system 100, 200 records the decision and updates itself for future queries and procedures.

Additionally, upon receiving a request for an authorization request, the real-time payment system 100, 200 performs the following process steps including checking and validating requestor user credentials, checking and validating authorization request application, and identifying the recipient of the authorization request application.

When a request has its status altered, the real-time payment system 100, 200 alerts the users concerned through specific notifications including pending authorization, granted authorization, declined/denied authorization and cancelled authorization.

In short, a method for facilitating user authorization and consent implemented in the real-time payment system 100, 200 is disclosed comprising in an embodiment of the present invention the steps of receiving transaction information from a payor user, including payor's key, transaction amount, or due date; sending an authorization request to a recipient user; receiving a response from the recipient user, the response indicating authorization or denial of the transaction; notifying the payor user of the recipient user's response; and executing the transaction upon receiving authorization from the recipient user.

In alternative embodiment of the present invention, the method for facilitating user authorization and consent comprises additionally requiring additional authentication for certain transactions, and where the authorization request may be sent via email, SMS or within the real-time payment system.

From the method for facilitating user authorization and consent, a user authorization and consent facilitation module 120, 220 for facilitating user authorization and consent derives therefrom comprises a user interface 121, 221 configured to receive transaction information from a payor user, including a payor's key, transaction amount, and due date; a communication module 122, 222 configured to send an authorization request to the recipient user; an authorization module 123, 223 configured to receive a response from the recipient user, the response indicating authorization or denial of the transaction; a notification module 124, 224 configured to notify the payor user of the recipient user's response; and a transaction processing module 125, 225 configured to execute the transaction upon receiving authorization from the recipient user.

In an alternate embodiment of the user authorization and consent facilitation module 120, 220 of the real-time payment system 100, 200 of the present invention, the authorization module 123, 223 is further configured to require additional authentication for certain transactions and to send notifications via email, SMS, or within the system.

### Individual or Batch Application

An authorization request application can occur individually or in batch. In batch applications, the recipient user institution provides a file containing a set of information identifying both the user to be charged as well as the conditions associated with the charge such as transaction values, dates, inter alia, of the charge. The real-time payment system 100, 200 uses a standardized file which meets all economic sectors of the financial industry, and which allows greater flexibility in its use, on top of being very adaptable to the diverse market intricacies and specificities. On top of the standardized file, other layouts or configurations may be used, such as JSON, or CSV, inter alia, and which also meets all segments.

Authorization requests are also loaded via application programming interface (API) calls specifically developed for that purpose and, in an integration embodiment, the JSON standard is adopted.

When an authorization is given, a QR Code that uniquely identifies the charge/collection is generated, stored and may be queried or accessed subsequently about its validity or authenticity, in addition to its other characteristics, updated value and other instructions for its payment.

In short, a method for processing one or more batch authorization requests implemented in the real-time payment system 100, 200 is disclosed comprising in an embodiment of the present invention the steps of receiving a file containing one or more authorization requests, each request including transaction details such as value, description, or due date; sending one or more authorization requests to a respective recipient user; receiving one or more responses from the recipient user, each response indicating authorization or denial of the respective transaction; notifying the payer user of the recipient users' response; and executing the transaction upon receiving authorization from the recipient user. In an alternative embodiment of the present invention, the method for processing one or more batch authorization requests comprises additionally validating credentials of the requestor before processing the one or more authorization requests and updating the system records based on the one or more responses received from the recipient user. In yet another alternative embodiment of the present invention, wherein the file is in a standardized format such as JSON or CSV, and wherein the one or more authorization requests are sent via email, SMS, or within the real-time payment system 100, 200.

From the method for processing one or more batch authorization requests, a processing module 130, 230 derives therefrom and that is configured for processing one or more batch authorization requests and comprises a user interface 131, 231 configured to receive a file containing one or more authorization requests, each request including transaction details such as value, description, or due date; a communication module 132, 232 configured to send one or more authorization requests to a respective recipient user; an authorization module 133, 233 configured to receive a response from a recipient user, each response indicating authorization or denial of a respective transaction; a notification module 134, 234 configured to notify a payor user of the recipient user's response; and a transaction processing module 135, 235 configured to execute the transaction upon receiving authorization from the recipient user.

In an alternate embodiment of the processing module 130, 230 of the present invention, the file is in a standardized format such as JSON or CSV.

### Dynamic Path/Track Selection for Billing Execution

The real-time payment system architecture 100, 200 of the present invention selects automatically as a function of routing institutions, i.e. routing number, associated with the one or more keys involved in the collection/billing (RTF/RFP), the best path for commanding the request and carry out a charge/collection to be chosen among the options available from, for example, Rails which include FedNow, TCH, ACH, inter alia, which are enabled as a function of the users/parties involved in this process.

The real-time payment system 100, 200, using the routing number, identifies which paths or tracks can be used to meet user-directed charge/billing. These paths or tracks are used for routing these future charge/billing requests for the user.

In short, a method for dynamic path selection for billing execution implemented in the real-time payment system 100, 200 is disclosed comprising in an embodiment of the present invention the steps of automatically selecting a path for commanding a billing request based on one or more routing institutions associated with one or more keys involved in a billing process; identifying, using a routing number, one or more available paths for executing the billing request from a group of options including FedNow, TCH, and ACH; enabling the selected path as a function of the parties involved in the billing process; and routing the billing request through the identified path to execute the charge or collection. In yet another alternative embodiment of the present invention, the method for selecting a path for billing execution further comprises updating the one or more available paths based on changes in the one or more routing institutions or the users/parties involved. In an alternate embodiment of the method for selecting a path for billing execution of the present invention, the method further comprises updating one or more available paths based on changes in the one or more routing institutions. In yet another embodiment of the present invention, the step of automatically selecting a path for commanding a billing request based on the one or more routing institutions associated with the one or more keys involved in a billing process utilizes a decision making algorithm to evaluate routing efficiency and reliability, the step of identifying the one or more available paths for executing the billing request employs a database of routing numbers and associated institutions, the step of the enabling the selected path as a function of the parties involved in the billing process considers factors such as transaction type, amount, and priority, the step of routing the billing request through the identified path to execute the charge or collection ensures compliance with regulatory requirements and security protocols, and the step of updating the one or more available paths based on changes in the one or more routing institutions synchronizes with external databases to reflect the latest routing information.

From the method for dynamic path selection for billing execution, a dynamic path selection system module 140, 240 derives therefrom and that is configured to dynamically select one or more optimal paths for billing one or more processes based on real-time data and comprises a path selection module 141, 241 configured to automatically select a path for commanding a billing request based on one or more routing institutions associated with one or more keys involved in a billing process; a path identification module 142, 242 configured to identify, using a routing number, one or more available paths for executing the billing request from a group of options including FedNow, TCH, and ACH; a path enabling module 143, 243 configured to enable the selected path as a function of the users/parties involved in the billing process, and a routing module 144, 244 configured to route the billing request through the identified path to execute the charge or collection.

In an alternate embodiment of the real-time payment system 100, 200 of the present invention, the dynamic path selection module 140, 240 further comprises an update module 145, 245 configured to update one or more available paths based on changes in the one or more routing institutions. In yet another embodiment of the real-time payment system 100, 200 of the present invention, the path selection module 141, 241 utilizes a decision making algorithm to evaluate routing efficiency and reliability, the path identification module 142, 242 employs a database of routing numbers and associated institutions, the path enabling module 143, 245 considers factors such as transaction type, amount, and priority, the routing module ensures compliance with regulatory requirements and security protocols, and the update module 145, 245 periodically synchronizes with external databases to reflect the latest routing information.

In short, the dynamic path selection refers to the system module and process within the real-time payment system 100, 200 architecture of the present invention that automatically chooses the most suitable route for executing billing requests, ensuring optimal routing for billing one or more processes by continuously adapting to real-time data and conditions. The dynamic path selection involves several key steps and components including path selection by automatically selecting a route for a billing request based on one or more routing institutions associated with one or more keys involved in the billing process, path identification by using a routing number to identify one or more available paths for executing the billing request from diverse options, path enabling by enabling the selected path taking into consideration several factors, routing by routing the billing request through the identified path to execute the charge or collection, and path updating by updating one or more available paths based on changes in one or more routing institutions or users involved.

### Billing and Collection Portability

The real-time payment system 100, 200 architecture of the present invention undertakes complete billing and collection management and the corresponding authorizations and consent and allows a user to change accounts associated with their keys.

When changing the account associated with a key occurs, all authorized and consented billing or collection can be redirected or rerouted to the associated new account. The decision whether the billing or collection will be re-rerouted to the new account is made by the user at the moment of the change.

Thus, if redirection is requested, the real-time payment system 100, 200 performs autonomously the consent and authorization processes of the billing or collection for the new account. Otherwise, if the user requests to keep the billing or collection on the old account, this redirection does not occur, and future billing or collection remains in the same path as before. The billing or collection portability can also occur, not only by changing the account associated with the key, but also when the user decides to carry over the billing or collection and settle in another account or bank.

The billing and collection portability process is exactly the same in both cases, account change or account association with another key, and is requested by the paying user as desired.

For example, the Key “johndoe@banka.com” is associated with Bank A (Routing Number: 1234567, Account Number: 68726112) and has associated therewith the following billing or collection or charge authorization:

### AUT-1:4 Monthly Installments of US$500 Every 15th Day of the Month

When changing the Key “johndoe@banka.com” for a new Bank B (Routing Number: 7654321, Account Number: 798723921), the real-time payment system 100, 200 queries the user about keeping this billing or collection or charge to current bank A ou rerouting it to new Bank B.

If the option is for rerouting, it receives a request to authorize AUT-1 in such a way that the next charges or billing or collection are rerouted to Bank B, otherwise the charges or billing or collection continue to be routed to Bank A.

In short, a method for managing billing and collection portability implemented in the real-time payment system 100, 200 is disclosed comprising in an embodiment of the present invention the steps of receiving a user request to associate a new account with one or more keys; redirecting billing and collection activities to the new account based on user consent; automatically handling consent and authorization processes for the new account; and providing the user with an option to maintain billing and collection activities on the original account if desired.

From the method for managing billing and collection portability, a portability management module 150, 250 derives therefrom and is configured to manage the portability of billing and collection data across different platforms and comprises a user interface 151, 251 for receiving one or more requests to change one or more accounts associated with one or more keys; a processing unit 152, 252 for redirecting billing and collection activities to a new account upon user consent; a consent and authorization module 153, 253 for handling one or more processes autonomously; and a notification system module 154, 254 for informing users of the status of the one or more requests.

In short, the billing and collection portability refers to the module system and process within the real-time payment system 100, 200 architecture of the present invention that provides flexibility in transferring billing and collection activities from one account to another, seamless and efficiently, ensuring that billing and collection processes are not disrupted when a user decides to change their account details. The billing and collection portability particularly involves account change by enabling the user to switch an account associated with billing and collection keys, redirection or rerouting by authorizing billing and collection keys to be redirected to a new account based on the user's decision, autonomous handling by enabling the system to autonomously manage the consent and authorization processed for a new account, and consistency by providing consistency whether the user is changing the account linked to a key or carrying over billing/collection activities to another account or bank.

### QR Code Generation and Storage

The real-time payment system 100, 200 architecture of the present invention provides a sophisticated billing and collection service through the generation of one or more specialized QR Codes which streamlines billing and payment processes, ensuring flexibility and efficient management.

Each collection charge represented by a QR Code in the real-time payment system 100, 200 contains all the particular characteristics and defined by the recipient user, including all interest computation rules, fines, discounts, inter alia, as a function of the due date and payment date.

When a QR Code is accessed or queried, the real-time payment system 100, 200 redoes, validates and applies all conditions imposed for the collection charge, recalculating the value to be paid and the other payment instructions at the time of that access or query.

The real-time payment system 100, 200 also stores information related to the charge or collection and payment and allows the use of the information with great flexibility. Among the types of information stored in the QR code include charge or collection or payment recurrence, fixed or variable value, due date, expiration date and payment term date, interests date and absolute or relative interest value, discount date and absolute or relative discount value, whether payor may or may not change value, partial or installment payment control and treatment, when applicable.

When a payment or charge or collection has its status altered, the real-time payment system 100, 200 alerts the users involved in the transaction via specific notifications including accepted payment, scheduled payment, declined payment, payment failure, expired payment, overdue payment and approved or received payment.

In these several cases, a single conciliation mechanism is used allowing the recipient to experience a simple and efficient conciliation process, regardless of the path in which the collection or charge was settled, through the association of one or more identifiers provided by the recipient on time for the collection or payment charge.

A simplification of the various uses of the one or more QR Codes of the real-time payment system 100, 200 and their properties are shown in Table 2 below:

TABLE 2
QR Code Uses and Properties

| | Static | Dynamic | Recurring |
|---|---|---|---|
| Events and Properties | QR Code | QR Code | QR Code |
| Indefinite End Date | | | ✓ |
| Specific date | ✓ | ✓ | |
| Payor can change value | | ✓ | ✓ |
| Payor cannot change value | ✓ | | ✓ |
| Applicable for online and POS | ✓ | ✓ | |
| payment | | | |
| Applicable for Printed | ✓ | ✓ | ✓ |
| Charge/Collection | | | |
| Interest Value Calculation | ✓ | ✓ | ✓ |
| Suitable for Payment Transfer | | ✓ | |
| Between Parties | | | |
| Can be Paid after Due Date | | ✓ | |
| Payment Block After Due Date | ✓ | ✓ | ✓ |
| Suitable for purchases | ✓ | ✓ | |
| Suitable for payments | ✓ | | ✓ |

The real-time payment system 100, 200 serves various purposes in relation to collection charges, which regardless of their type, be in static, dynamic, recurrent, immediate, with due date, inter alia, are grouped according to several of their characteristics, providing users with a consolidated view of this set of titles.

In short, a method for managing billing and collection through one or more specialized QR codes implemented in the real-time payment system 100, 200 is disclosed comprising in an embodiment of the present invention the steps of generating a specialized QR Code representing a collection charge, with embedded information on interest computation rules, fines, discounts, expiration dates, and payment instructions; accessing the QR Code to initiate a recalculation of the payment value and other payment instructions based on the predefined one or more conditions associated with the collection charge; and storing billing and payment-related information, allowing for flexible use of the information, including billing or payment recurrence, expiration dates, interest calculations, discounts, and treatment of partial payments.

From the method for managing billing and collection through one or more specialized QR codes, a QR code generation and storage module 160, 260 derives therefrom and that is configured to generate and process one or more QR codes for billing and collection purposes and comprises a QR code generation module 161, 261 configured to generate one or more specialized QR codes representing one or more collection charges; a validation module platform 162, 262 configured to recalculate the value to be paid and other payment instructions based on conditions imposed for a specific collection charge when the QR Code is accessed; and a storage module 163, 263 configured to store information related to billing and payment.

In an alternate embodiment of the QR code generation and storage module 160, 260 of the present invention, each QR Code includes information regarding interest computation rules, fines, discounts, expiration dates, and payment instructions, and where the information related to billing and payment includes billing or payment recurrence, fixed or variable value types, expiration dates, interest calculations, discounts, and handling of partial payments.

### Visualization and Management of Collection and Billing Charges

The real-time payment system 100, 200 architecture of the present invention provides a visualization and management module 170, 270 of groups and titles allowing to identify, monitor and visualize the steps of the processing, scheduling, payment and/or receipt, delays, due dates, inter alia, and, from each processing stage, offering a series of actions and control and actuation procedures on the titles and the debtors or payors. Thus, from generation to payment, the real-time payment system 100, 200 of the present invention allows a complete monitoring of a collection and billing charge in all of its steps.

The real-time payment system 100, 200 provides and carries out a series of notifications to users to allow a complete monitoring of the charges and payments that occur in the platform. This set of notifications includes the following events:
Authorization request notifications for billing directed to the debtor or payor user
Authorized collection and billing request notifications directed to the recipient user
Declined collection and billing notifications directed to the recipient user
Collection and billing inclusion notifications directed to the recipient user and debtor or payor user
Collection and billing query or access notifications directed to the recipient user
Collection and billing exclusion notifications directed to the recipient user and debtor or payor user
Collection and billing expiration notifications directed to the recipient user and debtor or payor user
Collection and billing payment notifications directed to the recipient user and debtor or payor user
Collection and Billing rejection or refusal notifications directed to the recipient user

These notifications are forwarded to users via e-mail, SMS or through direct notification of the installed application or accessed through the website.

In short, a method for managing, visualizing and monitoring billing and collection processes implemented in the real-time payment system 100, 200 is disclosed comprising in an embodiment of the present invention the steps of enabling identification, monitoring, and visualization of processing stages, scheduling, payments, receipts, delays, and due dates; providing actions and control mechanisms at each stage for titles and debtors/payors; facilitating comprehensive monitoring of billing and collection charges from initiation to completion. In yet another alternative embodiment of the present invention, the method for managing and visualizing billing and collection processes further comprises generating and dispatching notifications to users for tracking charges and payments; including notifications for authorization requests, approvals, declines, inclusions, queries, exclusions, expirations, payments, and rejections; and delivering notifications via email, SMS, or direct application alerts.

From the method for managing, visualizing and monitoring billing and collection processes, a visualization and management module 170, 270 derives therefrom and that is configured to manage and visualize billing and collection processes and comprises a visualization and management enabling module 171, 271 configured to identify, monitor, and visualize processing stages, scheduling, payments, receipts, delays, and due dates; a control interface 172, 272 configured to provide one or more actions and control mechanisms at each stage for titles and debtors or payors; a monitoring interface 173, 273 configured to facilitate comprehensive tracking of billing and collection charges from initiation to completion.

In an alternate embodiment of the real-time payment system 100, 200 of the present invention, the visualization and management module further comprises a notification module 174, 274 configured to generate and dispatch one or more notifications to users for tracking one or more charges and payments, or one or more notifications for authorization requests, approvals, declines, inclusions, queries, exclusions, expirations, payments, and rejections; and a communication interface 175, 275 configured to deliver one or more notifications via email, SMS, or direct application alerts.

In yet another embodiments of the real-time payment system 100, 200 of the present invention, the user identification and key registration module 110, 210 is further configured to verify the user's identity using multi-factor authentication, the user authorization and consent facilitation module 120, 220 is further configured to log one or more user consent and authorization events for audit purposes, the processing module 130, 230 is further configured to handle one or more real-time authorization requests in addition to batch one or more authorization requests, the dynamic path selection module 140, 240 utilizes machine learning algorithms to optimize one or more billing paths based on historical data and real-time analytics, the portability management module 150, 250 supports data interoperability with external billing and collection systems via standardized application programming interfaces (APIs), the QR code generation and storage module 160, 260 is further configured to encrypt QR code data to ensure secure transactions, and the visualization and management module 170, 270 includes a dashboard interface 176, 276 for real-time monitoring and reporting of billing and collection activities.

In another embodiments of the method for processing payments in the real-time payment system 100, 200, the method includes additionally verifying the user's identity using multi-factor authentication during the sign-up process via the user identification and key registration module 110, 210, logging one or more user consent and authorization events for audit purposes via the user authorization and consent facilitation module 120, 220, handling one or more real-time authorization requests in addition to batch one or more authorization requests via the processing module 130, 230, utilizing machine learning algorithms to optimize one or more billing paths based on historical data and real-time analytics via the dynamic path selection module 140, 240, supporting data interoperability with external billing and collection systems via standardized application programming interfaces (APIs) via the portability management module 150, 250, encrypting QR code data to ensure secure transactions via the QR code generation and storage module 160, 260, and providing a dashboard interface for real-time monitoring and reporting of billing and collection activities via the visualization and management module 170, 270.

In other embodiments of the present invention, the real-time payment system 100, 200 and payment processing method include and are implemented using AI-enabled, quantum computing, and cybersecurity capabilities and measures including:
An AI module 280: The AI engine 281 enhances user experience, optimizes billing processes, and detects fraudulent activities. It leverages machine learning algorithms to verify the authenticity of social media accounts or aliases and provides personalized financial insights to users.
A quantum computing module 290: The quantum computing engine 291 solves complex optimization problems in real-time, further enhancing efficiency and decision-making.
A cybersecurity module 295: The cybersecurity module 295 protects the system against cyber threats, ensuring secure transactions and safeguarding user data.

In yet other embodiments of the present invention, the AI module of the real-time payment system 100, 200 and payment processing method include and are implemented using:
AI-Powered Fraud Detection Module 282: A machine learning model trained to detect fraudulent activities based on patterns in one or more user-defined parameters and QR Code usage.
Predictive Analytics Engine 283: An AI module that predicts future collection trends and adjusts one or more QR Code parameters to dynamically optimize billing and collection efficiency.
Natural Language Processing (NLP) Interface 284: An interface that uses NLP to understand and process one or more user-defined parameters entered in natural language, making the system more user-friendly.
Adaptive Learning Module 285: A module that continuously learns from past billing and collection data to improve the accuracy of interest computation, fines, and discounts.
AI-Driven Personalization Module 286: A feature that personalizes payment instructions and reminders based on one or more user behavior and preferences, enhancing user engagement and compliance.

In the embodiments of the real-time payment system 100, 200 and payment processing method of the present invention combining AI-enabled, quantum computing, and cybersecurity capabilities and measures, the overall real-time payment system 100, 200 and payment processing architecture creates a robust, efficient payment platform capable of processing real-time transaction with safety and optimization. The AI module 280 acts as a supervisor of all transactions, using machine learning (ML) algorithms to analyze data and identify risks. During processing, the AI module 280 assigns a preliminary risk score based on information such as value, origin, and destination of the transaction, also historical patterns of user's behavior. Techniques such as Random Forest, Language Learning Model (LLM), and ML are used to detect whether the transaction belongs to a cluster of suspected activities.

The AI module 280 adjusts the risk score dynamically as new data is processed and the user behavior is analyzed, determining whether the transaction is to be flagged as a potential fraud or proceed normally. The optimization of the charging or billing paths is also managed by the AI module 280, which suggests the best path according to user preferences and the conditions of the payment network. The real-time payment system 100, 200 architecture and payment processing method deriving thereof evaluates the participation of the issuing bank and of the recipient bank in the payment rail, the enabling of specific services and the time and cost efficiency to ensure that each transaction is efficiently and safely routed.

In other embodiments of the real-time payment system 100, 200 architecture and payment processing method of the present invention combining AI-enabled, quantum computing, and cybersecurity capabilities and measures, the dynamic path selection capabilities of the real-time payment system 100, 200 and payment processing method are enhanced as it uses historical algorithms and ML to evaluate factors such as the participation of banks in the payment rail, to determine if services are enabled by the end customer or user, by time and cost efficiency, and even by regional features and user behaviors.

For example, when processing a transaction, the real-time payment system 100, 200 architecture and payment processing method deriving thereof checks whether the issuing bank and the recipient bank are enabled to operate on a specific rail such as FedNow or TCH. If both banks participate in the same rail, the transaction is routed directly thereby minimizing the processing time. Otherwise, the real-time payment system 100, 200 architecture and payment processing method deriving thereof searches for an alternative that offers the best combination in terms of cost and efficiency.

Another scenario involves operational cost analysis. In situations where the operational cost is more relevant than the settlement time, the dynamic path selection capabilities of the real-time payment system 100, 200 and payment processing method are enhanced as the historical costs of each rail are evaluated and the most economically efficient path is suggested. For example, if the ACH offers a lower operational cost rate for large volumes of transactions and both banks support that network, the AI module 280 capabilities prioritize the use of the ACH minimizing operational costs and minimizing the need for extensive use of computer hardware and network resources.

In other embodiments of the real-time payment system 100, 200 architecture and payment processing method of the present invention combining AI-enabled, quantum computing, and cybersecurity capabilities and measures, the dynamic path selection capabilities of the real-time payment system 100, 200 and payment processing method are also enhanced as it is capable of adapting to specific conditions, such as regional behaviors or user preferences. If a rail has a greater utilization in a geographic region or for clients of a specific bank, the AI module 100, 200 adjusts the route to ensure an optimized and personalized experience. During high demand requests or occurrences, the real-time payment system 100, 200 architecture and payment processing method of the present invention uses ML algorithms to predict congestion and reroute the transactions to alternative routes, ensuring the completion of the transaction at the least amount of time possible and with the lowest cost, without compromising the stability, safety and security of the process.

In other embodiments of the real-time payment system 100, 200 architecture and payment processing method of the present invention combining AI-enabled, quantum computing, and cybersecurity capabilities and measures, quantum computation is applied mainly during the payment process and the settlement of transactions. By being able to perform multiple calculations in parallel and to solve complex problems almost instantaneously, the real-time payment system 100, 200 architecture and payment processing method of the present invention is enhanced and enabled to perform simultaneous validations of available balance, transaction limits control, alias resolution for bank account numbers or routing numbers, where the quantum computation helps to process the information in real-time, ensuring a fast and agile payment experience and without delays.

In other embodiments of the real-time payment system 100, 200 architecture and payment processing method of the present invention combining AI-enabled, quantum computing, and cybersecurity capabilities and measures, the cybersecurity module 295 is integrated throughout the real-time payment system 100, 200 architecture and all steps of the payment processing method, monitoring real-time activities for purposes of detecting and mitigating threats proactively. For example, when registering a new alias, a validation token is sent to the corresponding private channel such as email address, cellular telephone number or social media network account. After initial validation, a micro deposit is made to the account associated with the alias, and the user must confirm the received value to validate the account association. This multifactor authentication process ensures that only legitimate users are able to perform transactions and link these aliases to their accounts.

In other embodiments of the real-time payment system 100, 200 architecture and payment processing method of the present invention combining AI-enabled, quantum computing, and cybersecurity capabilities and measures, the AI module 280 validates the authenticity of the information provided and carries out multifactor verification during the integration onboarding process. Likewise, quantum computation manages the processing of simultaneous entries, such as balance validation and device authentication, ensuring that the onboarding steps are quickly and safely completed.

In short, by combing all of the previously mentioned AI-enabled, quantum computing and cybersecurity features, capabilities and measures, the real-time payment system 100, 200 architecture and payment processing method of the present invention monitors and protects the flow of transactions in real-time, using AI-enabled features of the AI module 280 to analyze risk and optimize routing, quantum computing features of the quantum computing module 290 for rapid validation and parallel processing, and cybersecurity features of the cybersecurity module 295 for proactively detecting and mitigating threats. This integrated novel combination of the real-time payment system 100, 200 architecture and payment processing method of the present invention thereby provides an efficient, scalable and highly secure real-time payment platform conceived to meet the demands of a dynamic financial market and in constant evolution.

In alternative embodiments of the real-time payment system 100, 200 architecture and payment processing method of the present invention, the real-time payment system 100, 200 architecture and payment processing method may be structured or implemented using a monolithic client server architecture which centralizes all components into a single, cohesive unit, ensuring data management and resource allocation. In a more specific and alternative embodiment of the real payment system 100, 200 architecture and payment processing method of the present invention structured or implemented using a monolithic client-server architecture, the real-time payment system 100, 200 comprises a single processor and a memory unit hosting all components in a unified architecture, the memory storing instructions that, when executed by the processor, enable the system to perform the following operations in the integrated modules comprising user identification and key registration 110, 210, user authorization and consent facilitation 120, 220, processing 130, 230 of batch authorization requests, dynamic path selection 140, 240, portability management 150, 250, QR code generation and storage 160, 260, and visualization management modules 170, 270, all of these modules integrated into a single software package running on the processor and performing its respective operations.

In yet other alternative embodiments of the real-time payment system 100, 200 architecture and payment processing method of the present invention, the real-time payment system 100, 200 architecture and payment processing method may be structured or implemented using a peer-to-peer client-server architecture where each peer (node) can act as both a client and a server, allowing for decentralized processing and data sharing, enhancing flexibility and scalability, as each peer can handle requests and provide services independently. In a more specific and alternative embodiment of the real payment system 100, 200 architecture and payment processing method of the present invention structured or implemented using a peer to peer client-server architecture, the real-time payment system 100, 200 comprises a processor and memory and where each client (user device) includes the processor and memory, allowing for decentralized processing and the server coordinating transactions but not executing them directly and, in the client side components, the user interface module, the authorization module, the notification module and the QR code interface operating on individual client devices handling local processing tasks and, in the server-side components, a central server hosting the user identification and key registration 110, 210, dynamic path selection 140, 240, portability management 150, 250, QR code generation and storage 160, 260, and visualization management modules 170, 270, the central server coordinating and validating transactions, but execution occurs directly between client devices.

In more alternative embodiments of the real-time payment system 100, 200 architecture and payment processing method of the present invention, the real-time payment system 100, 200 architecture and payment processing method may be structured or implemented using a hybrid client-server architecture where user client devices interact with the real-time payment system through various devices like mobile apps, web interfaces, and desktop applications, where centralized servers handle critical functions like data storage, transaction processing, and security management, where distributed nodes offload certain processing tasks to enhance performance and provide low-latency access, where a hybrid database system combines centralized and distributed databases for secure data storage, and where network infrastructure ensures secure, fast, and highly available communication between clients, servers, and distributed nodes. In a more specific and alternative embodiment of the real payment system 100, 200 architecture and payment processing method of the present invention structured or implemented using a hybrid client-server architecture, the real-time payment system 100, 200 comprises a processor and memory and combines the monolithic and peer-to-peer approaches, with certain modules running on the client-side and others on the server-side to balance load and enhance flexibility, where the client-side components include the user interface module, the authorization module, and the notification module operating on individual client devices, and these modules interacting with the server-side modules for verification and transaction processing, and where the server-side components have the server hosting the user identification and key registration 110, 210, dynamic path selection 140, 240, portability management 150, 250, QR code generation and storage 160, 260, and visualization and management modules 170, 270 and handling central processing tasks, coordinating with client devices as needed.

In other alternative embodiments of the real-time payment system 100, 200 architecture and payment processing method of the present invention, the real-time payment system 100, 200 architecture and payment processing method may be structured or implemented using a distributed client server architecture where user client devices interact with the real-time payment system 100, 200 through various devices like mobile apps, web interfaces, and desktop applications, where centralized servers handle critical functions like scalable cloud data storage, secure transaction processing, and security management, where distributed nodes offload certain processing tasks to enhance performance and provide low-latency access using edge computing and content delivery network for content delivery, where hybrid database system combines centralized and distributed databases for secure data storage, with encryption at rest and in transit, and where network infrastructure ensures secure, fast, and highly available communications using VPNs and high-speed fiber optic connections. In a more specific and alternative embodiment of the real payment system 100, 200 architecture and payment processing method of the present invention structured or implemented using a distributed client-server architecture, the real-time payment system 100, 200 comprises a processor and memory and features multiple servers, each hosting different modules to distribute processing load and increase redundancy and scalability, where the distributed server components include user identification and key registration 110, 210, user authorization and consent facilitation 120, 220, dynamic path selection 140, 240, portability management 150, 250, QR code generation and storage 160, 260, and visualization and management modules 170, 270 being deployed across several servers, where each server handles specific tasks and communicates with others to ensure cohesive system operation, and where the client-side components include the user interface module, the authorization module, the notification module, and QR code interface operating on individual client devices, and where the clients interact with different servers for various tasks, distributing the load and increasing system resilience.

In yet other alternative embodiments of the real-time payment system 100, 200 architecture and payment processing method of the present invention, the real-time payment system 100, 200 architecture and payment processing method may be structured or implemented using a cloud-native client-server architecture where user client devices provide the interface for user to interact with the real-time payment system 100, 200 through various devices like mobile apps, web interfaces, and desktop applications, and where cloud infrastructure hosts the backend services, databases, and other components/modules. In a more specific and alternative embodiment of the real payment system 100, 200 architecture and payment processing method of the present invention structured or implemented using a cloud-native client-server architecture, the real-time payment system 100, 200 comprises a processor and a memory utilizing cloud computing resources to dynamically allocate processing power and storage based on demand providing scalability and resilience, cloud server components including the user identification and registration module 110, 210, the user authorization and consent facilitation module 120, 220, the processing module 130, 230, the dynamic path selection module 140, 240, the portability management module 150, 250, the QR code generation and storage module 160, 260, and the visualization and management modules 170, 270 deployed as microservices in the cloud, and able to be scaled independently and communicate via APIs, and client-side components including the user interface module, the authorization module, the notification module, and the QR Code Interface operating on individual client devices, and the clients interacting with cloud-based microservices, allowing for real-time processing and dynamic resource allocation.

The embodiments described herein are merely exemplary and that a person skilled in the art may make many variations and modifications without departing from the spirit and scope of the invention. All such variations and modifications are intended to be included within the scope of the invention and the appended claims. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. A real-time payment system, comprising:
a processor;
a memory storing instructions that, when executed by the processor, cause the processor to perform operations comprising:
a user identification and key registration module configured to:
receive identifying information from a user via a user interface, including but not limited to name, physical address, email address, and cellular telephone number;
validate the received identifying information via a validation module;
generate a unique identifier key associated with a user's account via a key creation module, wherein the key is selected from a group consisting of email address, cellular phone number, social network account login/username, and generic identifier;
validate the key, except for the generic identifier, via a key validation module;
associate the validated key with a current, updated, and live account of the user via an account association module; and
inform the user of the successful or unsuccessful registration of the key via a notification module;
a user authorization and consent facilitation module configured to:
receive transaction information from a payor user via a user interface, including the payor's key, transaction amount, and due date;
send an authorization request to a recipient user via a communication module;
receive a response from the recipient user via an authorization module, the response indicating authorization or denial of the transaction;
notify the payor user of the recipient user's response via a notification module; and
execute a transaction upon receiving authorization from the recipient user via a transaction processing module;
a processing module configured to:
receive a file containing one or more authorization requests via a user interface, each request including transaction details such as value, description, and due date;
send one or more authorization requests to a respective recipient user via a communication module;
receive a response from the recipient user via an authorization module, each response indicating authorization or denial of the respective transaction;
notify the payor user of the recipient users' response via a notification module; and
execute the transaction upon receiving authorization from the recipient user via a transaction processing module;
a dynamic path selection module configured to:
automatically select a path for commanding a billing request based on one or more routing institutions associated with one or more keys involved in a billing process via a path selection module;
identify, using a routing number, one or more available paths for executing the billing request from a group of options including FedNow, TCH, and ACH via a path identification module;
enable the selected path as a function of the users/parties involved in the billing process via a path enabling module; and
route the billing request through the identified path to execute the charge or collection via a routing module;
a portability management module configured to:
receive one or more requests to change accounts associated with one or more keys via a user interface;
redirect billing and collection activities to a new account upon user consent via a processing unit;
handle consent and authorization processes autonomously via a consent and authorization module; and
inform users of the status of the one or more requests via a notification system module;
a QR code generation and storage module configured to:
generate specialized QR codes representing collection charges via a QR code generation module;
recalculate the value to be paid, and other payment instructions based on the conditions imposed for a specific collection charge when the QR Code is accessed via a validation module platform; and
store information related to billing and payment via a storage module;
a visualization and management module configured to:
identify, monitor, and visualize processing stages, scheduling, payments, receipts, delays, and due dates via a visualization and management enabling module;
provide actions and control mechanisms at each stage for titles and debtors/payors via a control interface;
facilitate comprehensive tracking of billing and collection charges from initiation to completion via a monitoring interface; and
provide real-time monitoring and reporting of billing and collection activities via a dashboard interface.

2. The real-time payment system of claim 1, wherein the user identification and key registration module is further configured to verify the user's identity using multi-factor authentication;
wherein the user authorization and consent facilitation module is further configured to log one or more user consent and authorization events for audit purposes;
wherein the processing module is further configured to handle one or more real-time authorization requests in addition to batch one or more authorization requests;
wherein the dynamic path selection module is further configured to utilize machine learning algorithms to optimize one or more billing paths based on historical data and real-time analytics;
wherein the portability management module is further configured to support data interoperability with external billing and collection systems via standardized application programming interfaces (APIs); and
wherein the QR code generation and storage module is further configured to encrypt QR code data to ensure secure transactions.

3. The real-time payment system of claim 1, wherein the memory storing instructions that, when executed by the processor, cause the processor to perform operations further comprising:
an AI module configured to enhance user experience, optimize billing processes, and detect fraudulent activities by leveraging machine learning algorithms to verify the authenticity of one or more social media accounts or aliases and provide personalized financial insights to users;
a quantum computing module configured to solve complex optimization problems in real-time, enhancing efficiency and decision-making; and
a cybersecurity module configured to protect the system against cyber threats, ensuring secure transactions and safeguarding user data.

4. The real-time payment system of claim 3, wherein the AI module further comprises:
an AI-powered fraud detection module configured to detect fraudulent activities based on patterns in one or more user-defined parameters and QR Code usage;
a predictive analytics engine configured to predict future collection trends and adjusts one or more QR Code parameters to dynamically to optimize billing and collection efficiency;
a Natural Language Processing (NLP) Interface configured to understand and process one or more user-defined parameters entered in natural language;
an adaptive learning module configured to continuously learn from past billing and collection data to improve the accuracy of interest computation, fines, and discounts; and
an AI-driven personalization module configured to personalize payment instructions and reminders based on one or more user behavior and preferences, enhancing user engagement and compliance.

5. A payment processing method, comprising:
providing a processor and a memory, wherein the memory stores instructions that, when executed by the processor, cause the processor to perform operations comprising:
user identification and key registration via a user identification and registration module by:
receiving identifying information from a user via a user interface, including but not limited to name, physical address, email address, and cellular telephone number;
validating the received identifying information via a validation module;
generating a unique identifier key associated with a user's account via a key creation module, wherein the key is selected from a group consisting of email address, cellular phone number, social network account login/username, and generic identifier;
validating the key, except for the generic identifier, via a key validation module;
associating the validated key with a current, updated, and live account of the user via an account association module; and
informing the user of the successful or unsuccessful registration of the key via a notification module;
user authorization and consent facilitation through a user authorization and consent facilitation module by:
receiving transaction information from a payor user via a user interface, including the payor's key, transaction amount, and due date;
sending an authorization request to a recipient user via a communication module;
receiving a response from the recipient user via an authorization module, the response indicating authorization or denial of the transaction;
notifying the payor user of the recipient user's response via a notification module; and
executing a transaction upon receiving authorization from the recipient user via a transaction processing module;
processing of one or more batch authorization requests using a processing module by:
receiving a file containing one or more authorization requests via a user interface, each request including transaction details such as value, description, and due date;
sending one or more authorization requests to a respective recipient user via a communication module;
receiving a response from the recipient user via an authorization module, each response indicating authorization or denial of the respective transaction;
notifying the payor user of the recipient users' response via a notification module; and
executing the transaction upon receiving authorization from the recipient user via a transaction processing module;
dynamic path selection through a dynamic path selection module by:
automatically selecting a path for commanding a billing request based on one or more routing institutions associated with one or more keys involved in a billing process via a path selection module;
identifying, using a routing number, one or more available paths for executing the billing request from a group of options including FedNow, TCH, and ACH via a path identification module;
enabling the selected path as a function of the users/parties involved in the billing process via a path enabling module; and
routing the billing request through the identified path to execute the charge or collection via a routing module;
portability management across different platforms via a portability management module by:
receiving one or more requests to change accounts associated with one or more keys via a user interface;
redirecting billing and collection activities to a new account upon user consent via a processing unit;
handling consent and authorization processes autonomously via a consent and authorization module; and
informing users of the status of the one or more requests via a notification system module;
generating and processing QR codes for billing and collection purposes using a QR code generation and storage module by:
generating specialized QR codes representing collection charges via a QR code generation module;
recalculating the value to be paid, and other payment instructions based on the conditions imposed for a specific collection charge when the QR Code is accessed via a validation module platform; and
storing information related to billing and payment via a storage module; and
providing visualization, management, and monitoring of collection and billing charges through a visualization and management module by:
identifying, monitoring, and visualizing processing stages, scheduling, payments, receipts, delays, and due dates via a visualization and management enabling module;
providing actions and control mechanisms at each stage for titles and debtors/payors via a control interface;
facilitating comprehensive tracking of billing and collection charges from initiation to completion via a monitoring interface; and
providing real-time monitoring and reporting of billing and collection activities via a dashboard interface.

6. The method of claim 5, further comprising verifying the user's identity using multi-factor authentication during the sign-up process via the user identification and key registration module; and
logging one or more user consent and authorization events for audit purposes via the user authorization and consent facilitation module;
handling one or more real-time authorization requests in addition to batch one or more authorization requests via the processing module;
utilizing machine learning algorithms to optimize one or more billing paths based on historical data and real-time analytics via the dynamic path selection module;
supporting data interoperability with external billing and collection systems via standardized application programming interfaces (APIs) via the portability management module; and
encrypting QR code data to ensure secure transactions via the QR code generation and storage module.

7. The method of claim 5, further comprising:
enhancing user experience, optimizing one or more billing processes, and detecting fraudulent activities by leveraging machine learning algorithms to verify the authenticity of one or more social media accounts or aliases and provide personalized financial insights to users through an AI module;
solving complex optimization problems in real-time, enhancing efficiency and decision-making through a quantum computing module; and
protecting the real-time payment system against cyber threats, ensuring secure transactions and safeguarding user data through a cybersecurity module.

8. The method of claim 7, further comprising:
detecting fraudulent activities based on patterns in one or more user-defined parameters and QR Code usage through an AI-powered fraud detection module;
predicting future collection trends and adjusts one or more QR Code parameters to dynamically optimize billing and collection efficiency through a predictive analytics engine;
understanding and processing one or more user-defined parameters entered in natural language through a Natural Language Processing (NLP) Interface;
continuously learning from past billing and collection data to improve the accuracy of interest computation, fines, and discounts, through an adaptive learning module; and
personalizing payment instructions and reminders based on one or more user behavior and preferences, enhancing user engagement and compliance, through an AI-driven personalization module.

9. A non-transitory computer-readable storage medium storing instructions that, when executed by a processor, cause the processor to perform a method for processing payments in a real-time payment system including a user identification and key registration module, a user authorization and consent facilitation module, a processing module, a dynamic path selection module, a portability management module, a QR code generation and storage module, and a visualization and management, the method comprising:
user identification and key registration via the user identification and registration module by:
receiving identifying information from a user via a user interface, including but not limited to name, physical address, email address, and cellular telephone number;
validating the received identifying information via a validation module;
generating a unique identifier key associated with a user's account via a key creation module, wherein the key is selected from a group consisting of email address, cellular phone number, social network account login/username, and generic identifier;
validating the key, except for the generic identifier, via a key validation module;
associating the validated key with a current, updated, and live account of the user via an account association module; and
informing the user of the successful or unsuccessful registration of the key via a notification module;
user authorization and consent facilitation through the user authorization and consent facilitation module by:
receiving transaction information from a payor user via a user interface, including the payor's key, transaction amount, and due date;
sending an authorization request to a recipient user via a communication module;
receiving a response from the recipient user via an authorization module, the response indicating authorization or denial of the transaction;
notifying the payor user of the recipient user's response via a notification module; and
executing a transaction upon receiving authorization from the recipient user via a transaction processing module;
processing of one or more batch authorization requests using the processing module by:
receiving a file containing one or more authorization requests via a user interface, each request including transaction details such as value, description, and due date;
sending one or more authorization requests to a respective recipient user via a communication module;
receiving a response from the recipient user via an authorization module, each response indicating authorization or denial of the respective transaction;
notifying the payor user of the recipient users' response via a notification module; and
executing the transaction upon receiving authorization from the recipient user via a transaction processing module;
dynamic path selection through the dynamic path selection module by:
automatically selecting a path for commanding a billing request based on one or more routing institutions associated with one or more keys involved in a billing process via a path selection module;
identifying, using a routing number, one or more available paths for executing the billing request from a group of options including FedNow, TCH, and ACH via a path identification module;
enabling the selected path as a function of the users/parties involved in the billing process via a path enabling module; and
routing the billing request through the identified path to execute the charge or collection via a routing module;
portability management across different platforms via the portability management module by:
receiving one or more requests to change accounts associated with one or more keys via a user interface;
redirecting billing and collection activities to a new account upon user consent via a processing unit;
handling consent and authorization processes autonomously via a consent and authorization module; and
informing users of the status of the one or more requests via a notification system module;
generating and processing QR codes for billing and collection purposes using the QR code generation and storage module by:
generating specialized QR codes representing collection charges via a QR code generation module;
recalculating the value to be paid, and other payment instructions based on the conditions imposed for a specific collection charge when the QR Code is accessed via a validation module platform; and
storing information related to billing and payment via a storage module; and
providing visualization, management, and monitoring of collection and billing charges through the visualization and management module by:
identifying, monitoring, and visualizing processing stages, scheduling, payments, receipts, delays, and due dates via a visualization and management enabling module;
providing actions and control mechanisms at each stage for titles and debtors/payors via a control interface;
facilitating comprehensive tracking of billing and collection charges from initiation to completion via a monitoring interface; and
providing real-time monitoring and reporting of billing and collection activities via a dashboard interface.

10. The non-transitory computer-readable storage medium of claim 9, wherein the instructions further cause the processor to:
verifying the user's identity using multi-factor authentication during the sign-up process via the user identification and key registration module; and
logging one or more user consent and authorization events for audit purposes via the user authorization and consent facilitation module;
handling one or more real-time authorization requests in addition to batch one or more authorization requests via the processing module;
utilizing machine learning algorithms to optimize one or more billing paths based on historical data and real-time analytics via the dynamic path selection module;
supporting interoperability with external billing and collection systems via standardized application programming interfaces (APIs) via the portability management module; and
encrypting QR code data to ensure secure transactions via the QR code generation and storage module.

11. The non-transitory computer-readable storage medium of claim 9, wherein the instructions further cause the processor to:
enhancing user experience, optimizing one or more billing processes, and detecting fraudulent activities by leveraging machine learning algorithms to verify the authenticity of one or more social media accounts or aliases and provide personalized financial insights to users through an AI module;
solving complex optimization problems in real-time, enhancing efficiency and decision-making, through a quantum computing module; and
protecting the real-time payment system against cyber threats, ensuring secure transactions and safeguarding user data through a cybersecurity module.

12. The non-transitory computer-readable storage medium of claim 11, wherein the instructions further cause the processor to:
detecting fraudulent activities based on patterns in one or more user-defined parameters and QR Code usage through an AI-powered fraud detection module;
predicting future collection trends and adjust one or more QR Code parameters to dynamically optimize billing and collection efficiency through a predictive analytics engine;
understanding and processing one or more user-defined parameters entered in natural language through a Natural Language Processing (NLP) Interface;
continuously learning from past billing and collection data to improve the accuracy of interest computation, fines, and discounts, through an adaptive learning module; and
personalizing payment instructions and reminders based on one or more user behavior and preferences, enhancing user engagement and compliance, through an AI-driven personalization module.
